(19) United States
(12) Patent Application Publication
(10) Pub. No.: US 2026/0347528 A1
(43) Pub. Date: Nov. 5, 2026

(54) POLYISOCYANURATE PLASTICS WITH RUBBER-LIKE PROPERTIES

(71) Applicant: SIKA TECHNOLOGY AG, Baar (CH)

(72) Inventors: Michael HUBER, Zürich (CH); Michael SCHLUMPF, Stallikon (CH); Andrea BATTISTI, Zürich (CH); Antonio CORSARO, Regensdorf (CH); David HOFSTETTER, Winterthur (CH)

(73) Assignee: SIKA TECHNOLOGY AG, Baar (CH)

(21) Appl. No.: 19/109,959

(22) PCT Filed: Sep. 8, 2023
(86) PCT No.: PCT/EP2023/074745

§ 371 Date: Mar. 7, 2025

(30) Foreign Application Priority Data
Sep. 9, 2022 (EP) 22194889.6

(51) Int. Cl. C08G 18/02; C08G 18/10; C08K 3/04; C08K 3/22; C09D 7/40; C09D 7/61; C09D 175/08

(52) U.S. Cl. CPC C08G 18/022; C08G 18/10; C09D 7/61; C09D 7/69; C09D 175/08; C08K 3/04; C08K 2003/2206; C08K 2201/005

(57) ABSTRACT

A polyisocyanurate plastic containing, in relation to the total plastic, a) a cured polymer including, in relation to the total polymer, at least 75 weight-% of polyether chains, 1 to 5.2 weight-% of urethane groups, and 0.7 to 7 weight-% of isocyanurate groups; b) at least 20 weight-% of at least one filler. The polyisocyanurate plastic shows pronounced rubber-like properties with a low modulus of elasticity, a low glass transition temperature and a surprisingly high dimensional stability with a high elastic recovery after compression, without the tendency to get brittle over time. It is easily available and is particularly suitable for uses such as shock absorber, sealant, adhesive or gap filler, particularly gap filler with a high thermal conductivity, suitable for the contact with electronic elements or devices, particularly batteries of electric vehicles.

### TECHNICAL FIELD

The invention relates to polyisocyanurate plastics and their use as elastomers with rubber-like properties.

### STATE OF THE ART

Natural and synthetic rubber is obtained through vulcanization, leading to durable elastomers. Rubber has a low glass transition temperature and a good dimensional stability with a high elastic recovery after pressure. Among other uses, rubber is particularly suitable for elastic seals or dampening materials, for example as a component of shock absorbers in vehicle construction. Over time, however, rubber tends to become brittle due to oxidation by air and loses its elasticity, which means that the rubber has to be replaced regularly. Hence, there is a need for an elastic plastic with rubber-like properties which does not tend to become brittle upon use. Polyurethanes are elastic plastics that are widely used in industry. They have a good elasticity and an adjustable hardness from soft-elastic to tough-elastic, i.e., with a low or a higher modulus of elasticity. Polyurethanes are usually cured through the reaction of isocyanate groups with polyols and/or moisture to form urethane bonds and—in the case of reaction with moisture—also urea bonds. However, the use of polyurethane plastics entails a number of difficulties. In the case of one-pack systems, the water required for curing must penetrate from the outside in the form of atmospheric moisture and there is always a risk of blistering. This is limiting the application of such systems in thick layers and between moisture-tight substrates. The problem with two-pack systems comprising a polyol component and an isocyanate component is that the dosing of the components must be very accurate in order to achieve the exact stoichiometry for the curing reaction to provide the desired material properties. In addition, the isocyanate groups can react not only with the hydroxyl groups of the polyols, but also with any water present. Particularly in high ambient humidity, this can trigger the formation of bubbles and cause incomplete polymerisation to end up with reduced strength and elasticity. Another disadvantage of polyurethane elastomers is that their dimensional stability after compression is significantly lower than that of rubber, meaning that they exhibit a high compression set and show a significant extent of irreversible plastic deformation upon compression, especially at elevated temperatures. Therefore, polyurethane plastics are not usable for applications with high demands on long-lasting dimensional stability after repeated compression and relaxation, such as for shock absorbers.

Further known are plastics which are crosslinked by isocyanurate groups. Isocyanurate groups are formed by the trimerisation of isocyanate groups. Such a curing is obtained by the addition of special alkaline catalysts. Trimerisation curing does not need moisture and the systems are quite tolerant towards mixing errors upon dosage of the trimerisation catalyst. However, the known polyisocyanurate plastics are mostly stiff, high-strength materials with a high glass transition temperature. They are typically used as adhesives, resins for composite materials and varnish-like coatings of high durability.

US 2022/0145149 describes anhydrously curing polyisocyanate-based adhesives, which cure by trimerisation. They have a high content of isocyanate groups which enables the desired high adhesive strength.

EP 2,137,224 describes polyisocyanate-based adhesives suitable for the lamination of packaging films. These adhesives are cured by the reaction of the polyisocyanate with a substoichiometric amount of polyol in the presence of a trimerisation catalyst. A balanced and not too high amount of polyol is needed to obtain high adhesive forces.

U.S. Pat. No. 5,102,918 describes compositions which are cured by the reaction of a polyisocyanate with a substoichiometric amount of polyol in the presence of a trimerisation catalyst, whereby rigid materials are obtained.

U.S. Pat. No. 3,697,485 describes electrical potting compounds obtained by curing a mixture of isocyanate-functional polymers and polyisocyanates by trimerization of the isocyanate groups. The obtained cured plastics are not soft enough to show rubber-like properties.

### SUMMARY OF THE INVENTION

The task of this invention is to provide an elastic plastic with rubber-like properties, particularly with a high dimensional stability and a compression set that is comparable to rubber, which overcomes the drawbacks of state-of-the-art plastics, particularly in terms of losing elasticity over time.

This task is surprisingly achieved with the polyisocyanurate plastic as described in claim 1. The inventive plastic contains a cured polymer with a very high content of polyether chains and a low content of urethane and isocyanurate groups. It further contains at least 20 weight-% of at least one filler and a catalyst for the trimerisation of isocyanate groups, whereby the trimerisation-catalyst is present during the curing reaction and may disappear after curing, for example by evaporation and/or decomposition.

The inventive polyisocyanurate plastic shows a surprisingly high dimensional stability under repeated compression stress, which is significantly higher than that of a corresponding conventional polyurethane plastic which is substantially free of isocyanurate groups. The inventive polyisocyanurate plastic shows pronounced rubber-like properties including a very low compression set and does not tend to lose its elasticity over time. It has a very low glass transition temperature, a low modulus of elasticity and a high dimensional stability in connection with a low compression set, particularly after compression at elevated temperatures such as 70 °C. The polyisocyanurate plastic is soft-elastic without getting brittle in cold conditions such as −20 °C. It is highly stable towards heat and humidity and shows a good mechanical strength and toughness at good elasticity. The contained filler enables further beneficial properties, whereby trimerisation curing surprisingly is not affected negatively by the filler. High amounts of carbon black fillers enable a particularly high toughness together with an excellent dimensional stability. High amounts of thermally conductive fillers enable plastics which are particularly suitable for the contact with electronic elements or devices, particularly batteries of electric vehicles, which generate a high amount of heat under heavy load. The inventive polyisocyanurate plastic is particularly easily obtainable by curing a composition containing a suitable isocyanate-functional polymer by adding a trimerisation catalyst. There is a high tolerance towards mixing errors upon addition of the trimerisation catalyst; and there is no water needed for the curing, and no substances are released upon curing, which enables the application in high layer thicknesses and in mostly closed environments such as for the filling of gaps or cavities.

With these unique properties, the inventive polyisocyanurate plastic is perfectly suitable for applications where an elastic material is needed with soft-elastic and vibration-dampening properties and a particularly high dimensional stability in connection with a low compression set. The inventive polyisocyanurate plastic is particularly suitable as thermal conductive gap filler for the contact with electronic elements or devices, particularly batteries of electric vehicles, where the plastic can accommodate thermal expansion and contraction of the battery elements during charging and de-charging cycles, which is called battery breathing. Further particularly preferred is the use as shock absorbing plastic, particularly for encasing the steel springs of shock absorbers for vehicles.

Other aspects of the invention are described in other independent claims. Preferred aspects of the invention are described in dependent claims.

### DETAILED DESCRIPTION OF THE INVENTION

The subject of the invention is a polyisocyanurate plastic containing
a) a cured polymer comprising, in relation to the total polymer,
   at least 75 weight-% of polyether chains,
   1 to 5.2 weight-% of urethane groups, and
   0.7 to 7 weight-% of isocyanurate groups,
b) at least 20 weight-%, in relation to the total plastic, of at least one filler.

In this document, the term “isocyanurate group” refers to a functional group of the formula

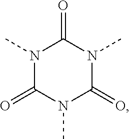

which is obtainable by the trimerisation of isocyanate groups.

In this document, the term “isocyanate group” refers to a functional group of the formula

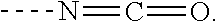

In this document, the term “urethane group” refers to a functional group of the formula

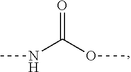

which is obtainable from the reaction of an isocyanate group with a hydroxyl group.

In this document, a dashed line in the formulas represents the bond between a substituent and the associated residue of the molecule.

In this document, the content of polyether chains in the cured polymer is being calculated from the content of polyether polyols in the cured polymer. All polyether polyols employed in the synthesis of the isocyanate-functional polymer to be cured within the polyisocyanurate plastic fully correspond to the content of polyether chains in the cured polymer with adequate accuracy. In other words, the mass amount of these polyols corresponds to the mass amount of polyether chains in the cured polymer and hence allow calculation of the mass percentage of polyether chains within this cured polymer.

In this document, the content of urethane groups in the cured polymer is being calculated from the content of hydroxyl groups which have reacted with isocyanate groups thereby forming urethane groups in the cured polymer, whereby the molecular weight of the urethane group is 59 g/mol (—NH—CO—O—). Hence, the molar content of urethane groups within the cured polymer fully corresponds to the molar content of hydroxyl groups of the polyols employed in the synthesis of the isocyanate-functional polymer to be cured within the polyisocyanurate plastic, from which the mass percentage of urethane groups within this cured polymer can be calculated.

In this document, the content of isocyanurate groups in the cured polymer is being calculated from the content of isocyanate groups in the uncured polymer before cure, thereby assuming that all isocyanate groups are being converted into isocyanurate groups by trimerization. The content of isocyanurate groups in the cured polymer (expressed as mass percentage in relation to the cured polymer) thus fully corresponds to the content of isocyanate groups (expressed as mass percentage in relation to the uncured polymer) in the uncured polymer.

The content of isocyanate groups in the uncured polymer is either calculated or preferably determined by reaction with a molar excess of dibutylamine and back titration of the remaining dibutylamine with aqueous hydrochloric acid, whereby the molecular weight of the isocyanate group is 42 g/mol (—NCO).

In this document, the term “NCO-content” refers to the content of isocyanate groups in weight-% of a molecule, a polymer or a composition.

In this document, substance names beginning with “poly” such as polyol or polyisocyanate, refer to substances containing two or more of the functional groups occurring in their name.

In this document, the term “plastic” refers to a synthetic or semi-synthetic material, which is based on crosslinked polymers and is solid at room temperature. The term “polyisocyanurate plastic” refers to a plastic based on a polymer which is crosslinked by isocyanurate groups.

In this document, the term “filler” refers to a powdery or granular solid material, preferably with a particle size below 2 mm, preferably below 0.5 mm, more preferably below 0.2 mm, particularly below 0.1 mm.

In this document, the term “shelf life stability” refers to the ability of a composition to be stored at room temperature in a suitable container under exclusion of moisture for a certain time interval, in particular several months, without undergoing significant changes in application or end-use properties.

In this document, the term “pot life” refers to the time period, during which a multi component composition can be applied after mixing of the components without defects.

In this document, the term “molecular weight” refers to the molar mass (g/mol) of a molecule. The term “average molecular weight” refers to the number average molecular weight (Mₙ) of an oligomeric or polymeric mixture of molecules. It is determined by means of gel permeation chromatography (GPC) against polystyrene as the standard, particularly with tetrahydrofuran as the mobile phase and a refractive index detector.

In this document, the term “weight-%” or “wt. %” refers to the mass fraction of a constituent of a composition based on the entire composition, unless stated otherwise. The terms “weight” and “mass” are used synonymously in this document. In this document “room temperature” refers to a temperature of 23 °C All industry standards and norms mentioned in this document refer to the versions valid at the time of filing the first application, if not specified.

Preferably, the content of polyether chains, in relation to the total polymer, is 75 to 97 weight-%, particularly 80 to 94 weight-%.

Preferably, the polyether chains consist of repetitive units selected from oxyethylene, oxy-1,2-propylene, oxy-1,3-propylene, oxy-1,4-butylene, oxy-1,2-butylene and mixtures thereof, whereby the content of oxyethylene units is less than 20 weight-%, preferably less than 10 weight-%, particularly less than 5 weight-%, based on the total of the polyether chains.

Preferred are oxyethylene, oxy-1,2-propylene, oxy-1,3-propylene or oxy-1,4-butylene units.

Particularly preferred are polyether chains consisting of oxy-1,2-propylene units or of poly(oxy-1,2-propylene) chains which are endcapped with a certain amount of oxyethylene units. Such materials are readily available and of high hydrophobicity, allowing polyisocyanurate plastics of high dimensional and hydrolytic stability.

Preferably, the polyether chains are free of oxyethylene units.

Most preferably, the polyether chains consist of oxy-1,2-propylene units.

Preferably, the content of urethane groups, in relation to the total polymer, is 1.5 to 4 weight-%, particularly 1.8 to 3.5 weight-%.

Preferably, the content of isocyanurate groups, in relation to the total polymer, is 1 to 6 weight-%, preferably 1.2 to 5 weight-%, more preferably 1.4 to 4 weight-%, particularly 1.5 to 3 weight-%.

Preferably, the cured polymer contains moieties after removal of the two isocyanate groups selected from the group consisting of the isomeric diphenylmethane diisocyanates (MDI), the isomeric toluene diisocyanates (TDI), naphthalene-1,5-diisocyanate (NDI), 1,5-pentane diisocyanate (PDI), 1,6-hexane diisocyanate (HDI), isophorone diisocyanate (IPDI), the isomeric dicyclohexylmethane diisocyanates (H₁₂MDI) and mixtures thereof.

These moieties are particularly bonded to the urethane and the isocyanurate groups of the cured polymer.

Preferred are the moieties of MDI, IPDI, HDI or mixtures thereof, particularly MDI or IPDI.

Most preferred are the moieties of MDI after removal of the two isocyanate groups. MDI is preferably 4,4′-diphenylmethane diisocyanate, which optionally contains some amounts of 2,4′-diphenylmethane diisocyanate and/or 2,2′-diphenylmethane diisocyanate.

The preferred cured polymers enable polyisocyanurate plastics with a particularly high heat stability and hydrolytic stability, a particularly low glass transition temperature, a low modulus of elasticity at high strength and toughness, and/or a particularly high dimensional stability in connection with a low compression set.

The inventive polyisocyanurate plastic preferably contains in relation to the total plastic 2 to 80 weight-% of the described cured polymer.

The inventive polyisocyanurate plastic further contains, in relation to the total plastic, at least 20 weight-% of at least one filler, preferably 20 to 95 weight-%, in particular 30 to 90 weight-%, of at least one filler. Preferred is a content of at least 30 weight-% of fillers. Such a plastic enables high dampening properties, particularly in relation to vibration and/or noise, and a particularly high dimensional stability with a high elastic recovery after compression at elevated temperature.

Suitable fillers are particularly ground or precipitated calcium carbonates (chalk), which are optionally surface coated with a fatty acid such as stearate, barium sulfate (barytes), slate, silicates (quartz), magnesiosilicates (talc), alumosilicates (clay, kaolin), dolomite, mica, glass bubbles, silicic acid, particularly highly dispersed silicic acids from pyrolytic processes (fumed silica), carbon black, graphite, microspheres, pigments, particularly titanium dioxide or iron oxides, calcium oxide, calcium hydroxide, aluminium oxide, aluminium hydroxide, boron nitride, aluminium nitride, magnesium oxide, magnesium hydroxide, zinc oxide, antimony trioxide, antimony pentoxide, boric acid, zinc borate, zinc phosphate, melamine borate, melamine cyanurate, ethylenediamine phosphate, ammonium polyphosphate, dimelamine orthophosphate, dimelamine pyrophosphate, hexabromocyclododecane, decabromodiphenyl oxide or tris(bromoneopentyl) phosphate.

The filler is preferably selected from the group consisting of calcium carbonates, barium sulfates, slate, silicates, magnesiosilicates, alumosilicates, dolomite, mica, fumed silica, carbon black, graphite, titanium dioxide, calcium oxide, calcium hydroxide, aluminium oxide, aluminium hydroxide, boron nitride, aluminium nitride, magnesium oxide, magnesium hydroxide, zinc oxide and any mixture of these fillers.

The polyisocyanurate plastic may contain further ingredients, particularly
plasticizers, particularly phthalates, particularly diisononyl phthalate (DINP) or diisodecyl phthalate (DIDP), hydrogenated phthalates, particularly hydrogenated DINP, which is diisononyl-1,2-cyclohexane dicarboxylate (DINCH), terephthalates, particularly bis(2-ethylhexyl) terephthalate (DEHT) or diisononyl terephthalate (DINT), hydrogenated terephthalates, particularly bis(2-ethylhexyl)-1,4-cyclohexane dicarboxylate, trimellitates, adipates, particularly dioctyl adipate (DOA), azelates, sebacates, citrates, benzoates, glycol ethers, glycol esters such as triethylene glycol bis(2-ethylhexanoate), polyether monools or polyether polyols with blocked hydroxyl groups particularly in the form of acetate groups, organic sulfonates or phosphates, particularly diphenylcresyl phosphate (DPK) or tris(2-ethylhexyl)phosphate (TOP), polybutenes, polyisobutenes or plasticizers obtained from natural fats or oils such as epoxidized soy or linseed oil,
fibres, particularly glass fibres, carbon fibres, metallic fibres, ceramic fibres, plastic fibres, particularly polyamide fibres or polyethylene fibres, or natural fibres such as wool, cellulose, hemp or sisal,
nanofillers such as graphene or carbon nanotubes,
pigments and/or dyes,
stabilizers against UV or heat or antioxidants.

Preferred plasticizers are glycol esters such as triethylene glycol bis(2-ethylhexanoate), phosphates such as diphenylcresyl phosphate or tris(2-ethylhexyl)phosphate, or usual plasticizers for polyurethanes such as DINP, DIDP, DINCH, DEHT, DINT or DOA.

In a preferred embodiment of the invention, the amount of fillers, in relation to the total plastic, is at least 50 weight-%, preferably at least 60 weight-%, more preferably at least 70 weight-%, particularly at least 80 weight-%, whereby the polyisocyanurate plastic optionally further contains at least one plasticizer. Preferred fillers for such a high filler load are mineral fillers with a mean particle size of more than 1 μm.

The mean particle size of fillers is preferably determined by laser diffraction analysis based on ISO 13320:2009, for example measured on a CILAS 920 particle size analyzer (Cilas) or on a Malvern Mastersizer 3000 (Malvern).

A particularly preferred polyisocyanurate plastic with such a high filler load contains at least one filler selected from graphite, aluminium oxide, aluminium hydroxide, boron nitride, aluminium nitride, magnesium oxide, magnesium hydroxide, zinc oxide and any mixture of these fillers. Preferred thereof are aluminium oxide, aluminium hydroxides or magnesium dihydroxide.

Such a polyisocyanurate plastic has a particularly high thermal conductivity. It is particularly suitable for the use as a gap filler and/or sealant with a high thermal conductivity, which is in contact with electronic elements or devices, particularly batteries of electric vehicles. Such a polyisocyanurate plastic can particularly cover, seal or bond batteries directly, or fill gaps within them. The rubber-like properties together with the good dimensional stability in connection with a low compression set enable a durable performance of the plastic with vibration dampening properties, whereby protecting the battery and enabling to dissipate heat, which is generated by the battery upon charging or heavy load. It thereby improves the function and lifetime of the battery.

A particularly preferred polyisocyanate plastic contains, in relation to the total plastic,
2 to 10 weight-%, preferably 2.5 to 5 weight-%, of the cured polymer,
70 to 95 weight-% of fillers selected from graphite, aluminium oxide, aluminium hydroxide, boron nitride, aluminium nitride, magnesium oxide, magnesium hydroxide and zinc oxide, and
0 to 30 weight-%, preferably 5 to 20 weight-%, of plasticizers.

Such a plastic has a particularly high thermal conductivity.

In a further preferred embodiment of the invention, the polyisocyanurate plastic contains, in relation to the total plastic, at least 10 weight-% of fillers with a mean particle size below 1 μm. Such fillers with a low particle size have a high surface and therefore need a high amount of fluid to wet the filler. That means, that a low amount of filler load in weight corresponds to a much higher filler load in volume. Preferred fillers of such low particle size are carbon black or fumed silica.

Particularly preferred is a polyisocyanurate plastic which contains, in relation to the total plastic, an amount of carbon black of at least 20 weight-%, preferably at least 30 weight-%. Such a plastic is particularly suitable for the use as a shock absorbing plastic. It has a particularly high strength and toughness and is particularly suitable for encasing the steel springs of shock absorbers for vehicles. It enables durable shock absorbing properties and a high dimensional stability after compression in a broad temperature range.

A further particularly preferred polyisocyanate plastic contains, in relation to the total plastic,
40 to 80 weight-%, preferably 50 to 70 weight-%, of the cured polymer,
20 to 50 weight-%, preferably 30 to 50 weight-%, of carbon black, and
0 to 40 weight-%, preferably 0 to 20 weight-%, of plasticizers.

Such a polyisocyanate plastic has particularly high shock absorbing properties.

The inventive polyisocyanate plastic is a solid material with elastic, rubber-like properties. It may be a coating, an adhesive, a sealing, or a molding comprising or consisting of the inventive polyisocyanate plastic. It is preferably used in a high layer thickness.

Preferably, the layer thickness of the inventive polyisocyanate plastic is at least 1 mm, preferably at least 2 mm, more preferably at least 4 mm, particularly at least 5 mm, whereby “layer thickness” means the smallest dimension in relation to length, width and height of the polyisocyanurate plastic.

Such a plastic has a high dimensional stability in connection with a low compression set and is able to dampen vibrations and other mechanical deformations effectively.

The inventive polyisocyanate plastic has a particularly high dimensional stability with a low compression set. Preferably, the deformation after compression at 70 °C is less than 50%, preferably less than 40%, particularly less than 30%, determined with a cylindrical sample of 13 mm in diameter and 6 mm in height after compressing the sample by 25% in height to 4.5 mm at 70 °C for 94 hours, followed by cooling the compressed sample to room temperature, releasing the pressure and measuring the loss in height in % based on the compressed height of 1.5 mm.

The inventive polyisocyanurate plastic further has a particularly low glass transition temperature. Preferably, the glass transition temperature is lower than −40 °C, particularly lower than −45 °C, determined by DMTA with striped samples (width 2.5 mm, length 8.5 mm, thickness 2 mm), measured in shear mode at an excitation frequency of 1 Hz and heating rate of 5 K/min, whereby the glass transition temperature corresponds to the temperature at the maximum of the loss modulus.

A further subject of the invention is a process to obtain the inventive polyisocyanurate plastic comprising the steps of
i) providing a composition comprising
   at least one isocyanate-functional polymer which contains, in relation to the total polymer, at least 75 weight-% of polyether chains, 1 to 5.2 weight-% of urethane groups and 0.7 to 4 weight-% of isocyanate groups,
   and at least 20 weight-%, in relation to the total composition, of at least one filler,
ii) adding at least one catalyst for the trimerisation of isocyanate groups, and
iii) curing the composition by trimerisation of the isocyanate groups, preferably at a temperature of 5 to 100 °C, more preferably 10 to 90 °C, particularly 15 to 80 °C.

The composition which is provided in step i) contains at least one isocyanate-functional polymer with at least 75 weight-% of polyether chains, 1 to 5.2 weight-% of urethane groups and 0.7 to 4 weight-% of isocyanate groups.

The isocyanate-functional polymer is preferably liquid at room temperature. It has preferably a low viscosity, preferably a viscosity of 1 to 200 Pa·s, preferably 1 to 100 Pa·s, more preferably 2 to 50 Pa·s, particularly 3 to 25 Pa·s, determined at 20 °C with a cone-plate rheometer with a cone diameter of 25 mm, cone angle of 1° at a cone-plate-distance of 0.05 mm at a shear rate of 10 s⁻¹.

The content and nature of the polyether chains of the isocyanate-functional polymer is preferably corresponding to the ones described and preferred for the cured polymer contained in the inventive polyisocyanurate plastic.

The content and nature of the urethane groups of the isocyanate-functional polymer is preferably corresponding to the one described and preferred for the cured polymer contained in the inventive polyisocyanurate plastic.

The content of isocyanate groups of the isocyanate-functional polymer, in relation to the total polymer, is preferably 1 bis 3.5% weight-%, particularly 1.5 bis 3% weight-%.

The isocyanate-functional polymer preferably has an average molecular weight Mₙ of 2′000 to 15′000 g/mol, particularly 3′000 to 10′000 g/mol.

The isocyanate-functional polymer is preferably obtained from the reaction of at least one monomeric diisocyanate and at least one polyether polyol.

Suitable monomeric diisocyanates are particularly 4,4′-diphenylmethane diisocyanate, 2,4′-diphenylmethane diisocyanate, 2,2′-diphenylmethane diisocyanate, 2,4-toluene diisocyanate, 2,6 toluene diisocyanate, 1,3-phenylene diisocyanate, 1,4-phenylene diisocyanate, naphthalene-1,5-diisocyanate, 3,3′-dimethyl-4,4′-diisocyanatodiphenyl, 1,4-butane diisocyanate, 1,5-pentane diisocyanate, 2-methyl-1,5-pentane diisocyanate, 1,6-hexane diisocyanate, 2,2 (4),4-trimethyl-1,6-hexane diisocyanate, 1,10-decane diisocyanate, 1,12-dodecane diisocyanate, cyclohexane-1,3-diisocyanate, cyclohexane-1,4-diisocyanate, 1-methyl-2,4-diisocyanatocyclohexane, 1-methyl-2,6-diisocyanatocyclohexane, isophorone diisocyanate, 4,4′-dicyclohexylmethane diisocyanate 1,3-bis(isocyanatomethyl)cyclohexane, 1,4-bis(isocyanatomethyl)cyclohexane, m-xylylene diisocyanate, p-xylylene diisocyanate or 3,6-bis-(9-isocyanatononyl)-4,5-di(1-heptenyl)cyclohexene (dimeryl diisocyanate).

Preferred thereof are the isomeric diphenylmethane diisocyanates (MDI), the isomeric toluene diisocyanates (TDI), naphthalene-1,5-diisocyanate (NDI), 1,5-pentane diisocyanate (PDI), 1,6-hexane diisocyanate (HDI), isophorone diisocyanate (IPDI) or the isomeric dicyclohexylmethane diisocyanates (H₁₂MDI) and mixtures thereof, preferably MDI, HDI or IPDI particularly MDI or IPDI.

Most preferred is MDI, preferably 4,4′-diphenylmethane diisocyanate, which optionally contains some 2,4′-diphenylmethane diisocyanate and/or 2,2′-diphenylmethane diisocyanate.

Suitable polyether polyols are particularly polyether polyols with repetitive units selected from oxyethylene, oxy-1,2-propylene, oxy-1,3-propylene, oxy-1,4-butylene, oxy-1,2-butylene and mixtures thereof, whereby the content of oxyethylene units is less than 20 weight-%, preferably less than 10 weight-%, particularly less than 5 weight-%, based on the total polyol.

Particularly preferred are poly(oxy-1,2-propylene)diols or on trimethylolpropane or glycerine started poly(oxy-1,2-propylene)triols, which optionally are endcapped with some ethyleneoxide. Preferred are poly(oxy-1,2-propylene)diols or triols which are free of oxyethylene units. Particularly preferred are poly(oxy-1,2-propylene)diols.

Preferably, the OH-number of the polyether polyol is in the range of 10 to 60 mg KOH/g.

Preferred are polyether polyols with a content of unsaturation below 0.02 meq/g, preferably below 0.01 meq/g.

Particularly preferred are polyether diols with an average molecular weight Mₙ of 1′800 to 12′000 g/mol, preferably 2′000 to 8′000 g/mol, or polyether triols with an average molecular weight Mₙ of 3′000 to 10′000 g/mol, preferably 4′000 to 8′000 g/mol. Most preferred are polyether diols.

The isocyanate-functional polymer is preferably prepared by combining the at least one monomeric diisocyanate and the at least one polyether polyol in a molar NCO/OH ratio of at least 1.3 preferably at least 1.5, more preferably at least 1.8, in the absence of moisture at a temperature in the range of 20 to 160 °C, preferably 40 to 140 °C, optionally in the presence of a suitable catalyst.

A particularly preferred isocyanate-functional polymer has a content of monomeric diisocyanate, in relation to the total polymer, of below 0.5 weight-%, preferably below 0.3 weight-%, more preferably below 0.2 weight-%, most preferably below 0.1 weight-%. Such a low monomer isocyanate-functional polymer allows curable compositions which have a content of monomeric diisocyanates of below 0.1 weight-% and are safe to use without special protective measures and do not require hazard labelling.

For such a polymer, the reaction is preferably conducted at a molar NCO/OH ratio of at least 3/1, preferably 3/1 to 10/1, particularly 3/1 to 8/1, followed by the removal of most of the remaining monomeric diisocyanate by a distillation process, preferably by thin film distillation or short path distillation under vacuum.

Another possibility to obtain an isocyanate-functional polymer with a low content of monomeric diisocyanate is by chemically reducing the content of monomeric diisocyanates, for example by adding small amounts of water, preferably in combination with a surfactant.

The composition provided in step i) further contains at least 20 weight-% of at least one filler, whereby the nature of the fillers preferably corresponds to the ones described and preferred for the inventive polyisocyanurate plastic. The amount of fillers in the composition provided in step i) can be lower the amount in the inventive polyisocyanurate plastic, as some additional filler can be added in step ii) together with the catalyst.

Besides the already mentioned further ingredients, which are optionally contained in the inventive polyisocyanurate plastic, the composition of step i) may preferably further contain small amounts of
oligomeric polyisocyanates such as a biuret or isocyanurate or uretdione or iminooxadiazinedione or allophanate of HDI, an isocyanurate of IPDI, an isocyanurate of PDI or a mixed isocyanurate based on TDI and HDI, preferably an isocyanurate of HDI,
drying agents, particularly molecular sieves, calcium oxide, highly reactive isocyanates such as p-tolylisocyanate, mono-oxazolidines such as Incozol® 2 (from Incorez) or orthoformic acid ester, whereby calcium oxide is particularly preferred,
adhesion promoters, particularly organoalkoxy silanes such as 3-isocyanatopropyltrimethoxysilane, 3-isocyanatopropyltriethoxysilane, 3-glycidoxypropyltrimethoxysilane, 3-glycidoxypropyltriethoxysilane, (meth)acrylosilanes, anhydridosilanes, carbamatosilanes, alkylsilanes or iminosilanes, or oligomers thereof, or titanates,
thickeners, such as bentonites, derivates of castor oil, hydrogenated castor oil, polyamides, polyamide waxes, polyurethanes, urea compounds, fumed silica, cellulose ethers or hydrophobically modified polyoxyethylenes,
organic solvents,
additives such as wetting agents, flow enhancers, leveling agents, defoamers, deaerating agents or biocides.

Preferably, the composition contains at least one drying agent, particularly calcium oxide. Calcium oxide reacts with water to form calcium hydroxide, thereby preventing water, which might be contained in the fillers, from reacting with isocyanate groups upon storage of the composition.

The composition provided in step i) is prepared by mixing all ingredients under exclusion of moisture to obtain a macroscopically homogeneous fluid or paste and stored in a moisture-tight container at ambient temperatures. A suitable moisture-tight container is preferably a bucket, a barrel, a hobbock, a bag, a sausage, a cartridge, a can, a bottle or a tube. With suitable packaging and storage, the composition shows a good shelf life stability.

In step ii), at least one catalyst for the trimerisation of isocyanate groups is added to the composition.

Suitable trimerisation catalysts are typically basic substances which catalyse the trimerisation of isocyanate groups at room temperature.

Suitable catalysts are particularly tertiary amines such as triethylamine, tributylamine, N,N-dimethylpiperazine or 1,4-diazabicyclo[2.2.2]octane (DABCO), or hydroxyamines such as triethanolamine or dimethylethanolamine. Further suitable catalysts are particularly amidines such as 1,8-diazabicyclo[5.4.0]undec-7-en (DBU), or guanidines such as 1,1,3,3-tetramethylguanidine or 1-hexyl-2,3-diisopropylguanidine. Further suitable catalysts are particularly phenols containing tertiary amine groups such as 2,4,6-tris(dimethylaminomethyl) phenol or disodium 2,6-bis(N-methyl-N-carboxymethyl-aminomethyl)-4-nonylphenol. Further suitable catalysts are particularly tetraalkylammonium hydroxides such as tetramethylammonium hydroxide, tetraethylammonium hydroxide, tetrabutylammonium hydroxide or trimethylhydroxypropylammonium hydroxide. Further suitable catalysts are particularly ammonium salts of carboxylates such as trimethylhydroxypropylammonium formate, trimethylammonium pivalate or tetraethylammonium acetate. Further suitable catalysts are particularly metal salts of carboxylates such as potassium acetate, potassium 2-ethylhexanoate, potassium neodecanoate, stannous octoate or sodium benzoate. Further suitable catalysts are particularly alkali metal phenolates such as sodium or potassium phenolate, or alkali metal alcoholates. Further suitable catalysts are particularly metal complex compounds of crown ethers, ethers or carboxylates, such as zirconium tetra-n-butyrate or zirconium tetra-2-ethylhexanoate. Further suitable catalysts are particularly phosphorous-containing substances such as trioctylphosphine or tetrabutylphosphoniumfluoride.

Particularly preferred trimerisation catalysts are tetraethylammonium hydroxide, trimethyl-2-hydroxypropylammonium formate, trimethylammonium pivalate, potassium 2-ethylhexanoate, potassium neodecanoate, disodium 2,6-bis(N-methyl-N-carboxymethyl-aminomethyl)-4-nonylphenol or stannous octoate.

Catalysts which are solid at room temperature are preferably used as a solution in a suitable liquid, preferably in glycol or diethyleneglycol and/or in a plasticizer.

Suitable trimerisation catalysts are commercially available, particularly as DABCO® TMR-2, DABCO® TMR-7, DABCO® TMR-12 or DABCO® TMR-31 (all from Evonik).

The amount of the added trimerisation catalyst, in relation to the total polyisocyanurate plastic which is obtained, is preferably 0.01 to 5 weight-%, more preferably 0.02 to 3 weight-%, particularly 0.05 to 1 weight-%.

The catalyst can be added in pure form, or in a concentrated solution containing 20 to 80 weight-% of the catalyst. However, due to the low amounts of catalyst in relation to the composition provided in step i), it is preferred to add the catalyst in a highly diluted form in order to get a mixing ratio in weight parts in the range of 10:1 to 1:1 between the composition and the diluted catalyst. Such a highly diluted catalyst preferably contains plasticizers and optionally fillers.

In a preferred embodiment of the process, the composition in step i) is called “isocyanate component” and the catalyst, which is added in step ii), is added in a diluted form as a so called “catalyst component”.

A preferred catalyst component contains plasticizers and optionally fillers, whereby the same fillers and plasticizers are preferred as the ones which are part of the isocyanate component.

Preferably, the isocyanate component and the catalyst component are separately packed, each stored in a moisture-tight container with a good shelf life stability, before they are mixed with each other in step ii) of the process.

The catalyst in step ii) can be added by any possible mixing procedure. Preferably, the addition of the catalyst in step ii) is performed by a static or a dynamic mixing procedure. Preferably, the catalyst is added in a diluted form, particularly as part of a catalyst component which further contains plasticizers and optionally fillers.

Step ii) is preferably performed at ambient temperatures, preferably at 5 to 40 °C, more preferably 10 to 35 °C, particularly 15 to 30 °C.

Upon mixing, the trimerisation catalyst gets in contact with the isocyanate-functional polymer, whereby the curing by trimerisation of the isocyanate groups of step iii) begins.

The curing in step iii) can be performed at ambient or at elevated temperatures, preferably at a temperature of 5 to 100 °C, more preferably 10 to 90 °C, particularly 15 to 80 °C.

During the curing step iii), the composition with the mixed-in catalyst is preferably in contact with one or more than one substrates, preferably moisture-tight substrates, which cover substantially the whole surface of the mixed material. This means, the surface of the mixed material is preferably not or only to a minimal extent exposed to moisture from the air during curing.

Upon curing, some side reactions may also occur, for example reactions of isocyanate groups with water to form urea groups, whereby carbon dioxide is released, or the formation of an asymmetrical trimer with functional groups of the formula

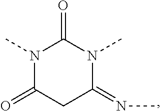

called iminooxadiazinedione groups.

The use of a suitable catalyst in a suitable amount and a hydrophobic isocyanate-functional polymer which has a low content or is free of ethyleneoxy units in the polyether chains ensure the formation of mostly isocyanurate groups upon curing. Preferably, at least 90% of the isocyanate groups present in the composition of step i) are transformed to isocyanurate groups upon curing.

Another subject of the invention is the use of the described polyisocyanurate plastic as gap filler, particularly as gap filler with high thermal conductivity, or as shock absorber, as vibration or noise dampening material, as coating, as adhesive or as sealing material. For these uses, the elastic, rubber-like properties and the high dimensional stability in connection with the low compression set of the inventive polyisocyanurate plastic, together with the easy applicability, the high tolerance towards mixing errors and without the need for moisture to cure and without the release of substances such as carbon dioxide, ethanol or methanol upon curing are of great advantage.

For these uses, the mixed composition from step ii) of the described process is preferably brought into the desired position and form as it is meant to cure, while it is still workable, which means within the pot life of the mixed composition. This process is called application.

The application of the mixed composition is preferably done by injecting it into a mold or—in the case of a gap filler—into a space or gap, or—in the case of a coating, sealant or adhesive—by placing it onto a substrate or between two or more substrates.

A particularly preferred application is done from a cartridge, preferably from a double cartridge through a static mixer, or from a combined mixing and pumping equipment with an integrated static or dynamic mixer.

Another particularly preferred application is done by simple pouring the mixed composition into a mold or gap and letting it fill the space to the desired extent.

A particularly preferred use is the use as gap filler and/or sealant with high thermal conductivity, which is in contact with electronic elements or devices, particularly batteries of electric vehicles. Such a polyisocyanurate plastic can cover, seal or bond batteries directly, or fill gaps within them. The rubber-like properties together with the high dimensional stability in connection with the low compression set enable a durable function of the plastic with vibration dampening properties, thereby protecting the battery and enabling to dissipate heat, which is generated by the battery upon charging or heavy load. It thereby improves the function and lifetime of the battery.

A further preferred use of some embodiments of the plastic according to the present invention in this regard is the use as elastic adhesive, especially in battery box bonding, such as for bonding of batter box lids. In such a use, the unique properties of the polyisocyanurate plastic according to the invention, including the elastic recovery as well as the heat and oxidation stability bring about useful technical advantages.

A further particularly preferred use is the use as shock absorbing plastic, particularly for encasing the steel springs of shock absorbers for vehicles. It enables durable shock absorbing properties and a high dimensional stability with a high elastic recovery after compression in a broad temperature range without getting brittle due to oxidation by air.

### BRIEF DESCRIPTION OF THE DRAWINGS

FIG. 1 shows the curves of the storage modulus and the loss modulus of example 2 vs temperature, determined with DMTA measurement as described.

### EXAMPLES

The following examples illustrate the present invention without being limiting.

“Standard climate conditions” means a temperature of 23±1 °C and a relative atmospheric moisture of 50±5% and is abbreviated with “SCC”.

Chemical substances not otherwise specified are from Sigma-Aldrich Chemie GmbH and were used as obtained.

### Preparation of Isocyanate-Functional Polymers

The NCO-content was determined by reaction with a molar excess of dibutylamine and back titration of the remaining dibutylamine with aqueous hydrochloric acid.

The viscosity was measured with a thermostated cone-plate-viscometer Rheotec RC30 (cone diameter 50 mm, cone angle 1°, cone-plate-distance 0.05 mm, shear rate 10 s⁻¹).

The content of monomeric diisocyanates was determined with HPLC (detection by photodiode array; 0.04 M sodium acetate/acetonitrile mobile phase) after derivatization with N-propyl-4-nitrobenzylamine.

Used substances
Desmophen® 5031 BT ethyleneoxide-terminated polyoxypropylene triol, OH-number 28 mg KOH/g (from Covestro)
Acclaim® 4200 polyoxypropylene diol, OH-number 28 mg KOH/g (from Covestro)
Voranol® CP 4755 ethyleneoxide-terminated polyoxypropylene triol, OH-number 35.0 mg KOH/g (from Dow)
Voranol® 1010 L polyoxypropylene diol, OH-number 112 mg KOH/g (from Dow)
MDI 4,4′-diphenylmethane diisocyanate (Desmodur® 44 MC L, from Covestro)
IPDI isophorone diisocyanate (Vestanat® IPDI, from Evonik)

### Polymer P1

725.0 g Desmophen® 5031 BT and 275 g MDI were reacted at 80 °C according to known procedures to form a mixture with an NCO-content of 7.6 weight-%. The volatile contents, particularly most of the monomeric MDI, were then removed from the mixture in a short path evaporator by distillation (jacket temperature 180 °C, 0.1 to 0.005 mbar), whereby a polymer with an NCO-content of 1.7 weight-%, a viscosity of 19 Pa's at 20 °C and a content of monomeric MDI of 0.04 weight-% was obtained.

### Polymer P2

1′300 g Acclaim® 4200, 2′600 g Voranol® CP 4755, 600 g MDI and 500 g diisodecylphthalate (plasticizer) were reacted at 80 °C according to known procedures, whereby a polymer with an NCO-content of 2.1 weight-%, a viscosity of 57 Pa·s at 20 °C and a content of monomeric MDI of approx. 2.2 weight-% was obtained.

### Polymer P3

727 g Acclaim® 4200 and 273 g MDI were reacted at 80 °C according to known procedures to form a mixture with an NCO-content of 7.6 weight-%. The volatile contents, particularly most of the monomeric MDI, were then removed from the mixture in a short path evaporator by distillation (jacket temperature 180 °C, 0.1 to 0.005 mbar), whereby a polymer with an NCO-content of 1.7 weight-%, a viscosity of 15 Pa's at 20 °C and a content of monomeric MDI of 0.08 weight-% was obtained.

### Polymer P4

400 g Acclaim® 4200 and 52 g MDI were reacted at 80 °C according to known procedures, whereby a polymer with an NCO-content of 1.8 weight-%, a viscosity of 32 Pa's at 20 °C and a content of monomeric MDI of approx. 2.3 weight-% was obtained.

### Polymer P5

780 g Desmophen® 5031 BT and 303 g IPDI were reacted at 80 °C according to known procedures to form a mixture with an NCO-content of 9.1 weight-%. The volatile contents, particularly most of the monomeric IPDI, were then removed from the mixture in a short path evaporator by distillation (jacket temperature 160 °C, 0.1 to 0.005 mbar), whereby a polymer with an NCO-content of 1.8 weight-%, a viscosity of 8.2 Pa's at 20 °C and a content of monomeric IPDI of 0.02 weight-% was obtained.

### Polymer P6

590 g Acclaim® 4200, 1180 g Voranol® CP 4755 and 230 g IPDI were reacted at 80 °C according to known procedures, whereby a polymer with an NCO-content of 2.1 weight-%, a viscosity of 22 Pa·s at 20 °C and a content of monomeric IPDI of approx. 1.8 weight-% was obtained.

### Polymer P7

600 g Voranol® 1010 L and 533.3 g IPDI were reacted at 80 °C according to known procedures to form a mixture with an NCO-content of 15.6 weight-%. The volatile contents, particularly most of the monomeric IPDI, were then removed from the mixture in a short path evaporator by distillation (jacket temperature 160 °C, 0.1 to 0.005 mbar), whereby a polymer with an NCO-content of 5.2 weight-%, a viscosity of 21.8 Pa's at 20 °C and a content of monomeric IPDI of 0.03 weight-% was obtained.

TABLE 1
Overview of the used isocyanate-functional polymers.

| Polymer | P1 | P2 | P3 | P4 | P5 | P6 | P7 |
|---|---|---|---|---|---|---|---|
| NCO-content [wt. %] | 1.7 | 2.3¹ | 1.7 | 1.8 | 1.8 | 2.1 | 5.2 |
| polyether content [wt. %]² | 88.9 | 86.7¹ | 88.9 | 88.5 | 90.0 | 88.5 | 69.3 |
| urethane content [wt. %] ³ | 2.6 | 3.0¹ | 2.6 | 2.6 | 2.7 | 3.0 | 8.2 |
| diisocyanate type | MDI | MDI | MDI | MDI | IPDI | IPDI | IPDI |
| content of monomeric | <0.1 | 2.2 | <0.1 | 2.3 | <0.1 | 1.8 | <0.1 |
| diisocyanate [wt. %] | | | | | | | |
| NCO-functionality | 2.3 | >2 | 2 | 2 | 2.3 | >2 | 2 |
| viscosity (20 °C) [Pa · s] | 19 | 57 | 15 | 32 | 8 | 22 | 22 |
| plasticizer content [wt. %] | 0 | 10 | 0 | 0 | 0 | 0 | 0 |

¹in relation to the total polymer without plasticizer
²calculated from the content of polyether polyol
³ calculated from the content of hydroxyl groups which reacted with isocyanate groups

Preparation of Cured Polymers Crosslinked with Isocyanurate Groups
Used catalysts
TMR-2 DABCO® TMR-2 containing trimethyl-2-hydroxypropyl ammonium formate (from Evonik)
TMR-7 DABCO® TMR-7 containing trimethylammonium pivalate (from Evonik)
TMR-12 DABCO® TMR-12 containing potassium 2-ethylhexanoate and trimethylammonium pivalate (from Evonik)
TMR-31 DABCO® TMR-31 containing disodium 2,6-bis(N-methyl-N-carboxymethyl-aminomethyl)-4-nonylphenol (from Evonik)
TOP trioctylphosphine 97% (from Sigma Aldrich)

### Compositions C-1 to C-10

For each composition, 100 weight parts of the isocyanate-functional polymer as given in Tables 2 to 4 were mixed with the catalyst as given in Tables 2 to 4 in the given amount (weight parts) by means of a centrifugal mixer (SpeedMixer™ DAC 150, FlackTek Inc.) under vacuum and exclusion of moisture, followed by applying the mixed composition for the tests as given below. For Composition C-5 (Ref.), the isocyanate-functional polymer and the HDI-isocyanurate were previously mixed with the centrifugal mixer in the given amounts before the catalyst was added as described.

To determine the mechanical properties, the composition was poured into a PTFE-coated mold to give a film with a layer thickness of approx. 2 mm, which was immediately covered with a PTFE-coated metal plate and stored in standard climate for 7 days. Then, the film was removed from the mold followed by punching dumbbell-shaped samples out of the cured film with a length of 75 mm at a bridge length of 30 mm and a bridge width of 4 mm. With the so-prepared samples, the tensile strength, the elongation (at break) and the e-modulus 5% (modulus of elasticity from 0.5 to 5% elongation) were determined according to DIN EN 53504 at a crosshead speed of 200 mm/min. These results are marked with “covered curing (RT)”. With some compositions, an identical film was prepared which was not covered with the PTFE-coated metal plate, but was cured with open surface in standard climate for 7 days. These results are marked with “open curing (SCC)”.

The Tg value (glass transition temperature) was determined by DMTA measurement as described for Example 1.

The cured films of all these examples were clear, homogeneous, and free of bubbles. The test results are given in Tables 2 to 4.

Reference compositions are marked with “(Ref.)”.

TABLE 2
Composition and properties of Compositions C-1 to C-5.

| | | | | | C-5 |
|---|---|---|---|---|---|
| Composition | C-1 | C-2 | C-3 | C-4 | (Ref.) |
| Polymer | P1 | P2 | P3 | P4 | P1 |
| | 100.0 | 100.0 | 100.0 | 100.0 | 75.0 |
| HDI-isocyanurate ¹ | — | — | — | — | 25.0 |
| catalyst TMR-7 | 0.12 | 0.12 | 0.12 | 1.0 | 0.12 |
| polyether content [wt. %] | 88.9 | 86.7 ³ | 88.9 | 88.5 | 66.6 |
| urethane content [wt. %] | 2.6 | 3.0 ³ | 2.6 | 2.6 | 2.0 |
| NCO content [wt. %] | 1.7 | 2.3 ³ | 1.7 | 1.8 | 7.0 |
| isocyanurate content after | 1.7 | 2.3 ³ | 1.7 | 1.8 | 12.8 |
| cure [wt. %] ² | | | | | |
| covered curing (RT): | | | | | |
| tensile strength [MPa] | 0.8 | 1.0 | 0.9 | 0.8 | 3.0 |
| elongation [%] | 50 | 55 | 65 | 75 | 27 |
| e-modulus 5% [MPa] | 1.7 | 0.8 | 1.8 | 1.4 | 17 |
| Tg [°C] | −44 | −41 | −37 | −36 | n.d. |
| open curing (SCC): | | | | | |
| tensile strength [MPa] | 0.6 | 0.5 | n.d. | 0.5 | 2.2 |
| elongation [%] | 70 | 50 | n.d. | 300 | 45 |
| e-modulus 5% [MPa] | 1.0 | 1.2 | n.d. | 0.5 | 7 |
| Tg [°C] | −42 | −39 | n.d. | −36 | n.d. |

“n.d.” means “not determined”
¹ NCO-content 23 wt. % (Desmodur ® N 3600, from Covestro)
² calculated from the isocyanate content
³ based on the total polymer (without plasticizer)

TABLE 3
Composition and properties of Compositions C-6 to C-8.

| | | | C-8 |
|---|---|---|---|
| Composition | C-6 | C-7 | (Ref.) |
| Polymer | P5 | P6 | P7 |
| | 100.0 | 100.0 | 100.0 |
| catalyst TMR-7 | 0.5 | 0.5 | 2.0 |
| polyether content [wt. %] | 90.0 | 88.5 | 69.3 |
| urethane content [wt. %] | 2.7 | 3.0 | 8.2 |
| NCO content [wt. %] | 1.8 | 2.1 | 5.2 |
| isocyanurate content after | 1.8 | 2.1 | 5.2 |
| cure [wt. %] ¹ | | | |
| covered curing (RT): | | | |
| tensile strength [MPa] | 0.8 | 0.7 | 1.5 |
| elongation [%] | 60 | 55 | 165 |
| e-modulus 5% [MPa] | 1.4 | 1.6 | 1.4 |
| Tg [°C] | −44 | −42 | −6 |
| open curing (SCC): | | | |
| tensile strength [MPa] | 0.5 | n.d. | n.d. |
| elongation [%] | 150 | n.d. | n.d. |
| e-modulus 5% [MPa] | 0.5 | n.d. | n.d. |
| Tg [°C] | −46 | n.d. | n.d. |

“n.d.” means “not determined”
¹ calculated from the isocyanate content

TABLE 4
Composition and properties of Compositions C-9 and C-10.

| Composition | C-9 | C-10 |
|---|---|---|
| Polymer P1 | 100.0 | 100.0 |
| catalyst | TMR-12 | TMR-31 |
| | 0.25 | 2.0 |
| covered curing (RT): | | |
| tensile strength [MPa] | 0.9 | 1.4 |
| elongation [%] | 52 | 160 |
| e-modulus 5% [MPa] | 2.3 | 1.9 |

### Compositions of Table 5

For each composition, 10 g of the isocyanate-functional polymer as given in Table 5 were mixed with the catalyst as given in Table 5 in the given amount (weight-% in relation to the total polymer) by means of the centrifugal mixer under vacuum and exclusion of moisture, followed by the determination of the tack-free time (TFT).

For the determination of TFT open (SCC), the freshly mixed material was applied in a layer thickness of approx. 5 mm on cardboard in standard climate followed by gently touching the surface with an LDPE pipette from time to time, until the touching did not leave any polymer residues on the pipette.

The test results are given in Table 5.

TABLE 5
Tack-free time (TFT) of different polymers with
various content of trimerisation catalyst

| | catalyst TMR-7 [wt. %] | | | | |
|---|---|---|---|---|---|
| TFT open (SCC): [hh:mm] | 0.25 | 0.5 | 1.0 | 2.0 | 4.0 |
| Polymer P1 | 00:03 | 00:01 | 00:01 | 00:01 | <00:01 |
| Polymer P2 | 00:02 | 00:01 | 00:01 | 00:01 | 00:01 |
| Polymer P3 | 00:37 | 00:09 | 00:03 | 00:02 | 00:02 |
| Polymer P4 | 06:31 | 03:39 | 00:49 | 00:21 | 00:14 |
| Polymer P5 | 00:30 | 00:28 | 00:21 | 00:17 | 00:15 |
| Polymer P6 | 00:31 | 00:28 | 00:20 | 00:15 | 00:11 |
| Polymer P7 (Ref.) | 01:20 | 01:10 | 00:46 | 00:30 | 00:22 |

### Examples 1 and 2 (Suitable for Use as Shock Absorbing Plastic)

For each composition, an Isocyanate component was prepared by mixing the ingredients as given in Table 6 in the given amounts (weight parts) by means of a planetary mixer under vacuum and exclusion of moisture and stored in a moisture-tight container.

Upon use, the catalyst component as given in Table 6 was added to the isocyanate component in the given amount (weight parts) and mixed by means of a centrifugal mixer (SpeedMixer™ DAC 150, FlackTek Inc.) under exclusion of moisture, followed by applying the mixed composition for the tests as given below.

The viscosity was measured 60 seconds after mixing with a Rheometer MCR 101 from Anton Paar in a rotation test with plate PP25, gap width 0.2 mm and speed 2 rpm at 25 °C.

To determine the mechanical properties, the composition was applied between two PTFE-coated foils and pressed to a film with a layer thickness of approx. 2 mm by means of two metal plates. The film covered with the two metal plates was then cured in an oven for 1 hour at 60 °C, followed by 23 hours at 80 °C The metal plates and the PTFE-coated foils were then removed from the cured film. The film was then stored in standard climate for 24 hours, followed by punching dumbbell-shaped samples out of the cured film with a length of 75 mm at a bridge length of 30 mm and a bridge width of 4 mm. With the so-prepared samples, the tensile strength, the elongation (at break) and the e-modulus 5% (modulus of elasticity from 0.5 to 5% elongation) were determined according to DIN EN 53504 at a crosshead speed of 200 mm/min. Additional test specimens were punched out of the cured film to determine the tear propagation and tested according to DIN ISO 34-1, method B (angular test specimen) at a crosshead speed of 500 mm/min. These results are marked with “curing 1 h 60 °C/23 h 80 °C”.

As a measure for heat stability, additional dumbbell-shaped samples were stored for 7 days in an oven at 100 °C followed by storage in standard climate for 24 hours. These samples were then tested for tensile strength, elongation and e-modulus 5% as described before. These results are marked with “after storage 7d 100 °C”.

The Shore A hardness was determined according to DIN 53505 with cylindrical samples of 20 mm diameter and a thickness of 5 mm which had been cured covered by a PTFE-coated metal plate in an oven for 1 hour at 60 °C, followed by 23 hours at 80 °C and then stored in standard climate for 24 hours.

DMTA measurements were done using a Rheoplus MCR 302 instrument from Anton Paar on striped samples (width 2.5 mm, length 8.5 mm, thickness 2 mm), which were cut from the cured film prepared to determine the mechanical properties. The measurement conditions were: measurement in shear mode, excitation frequency of 1 Hz and heating rate of 5 K/min. The samples were cooled to −100 °C and heated to 200 °C with determination of the storage modulus and the loss modulus, whereby the temperature at the maximum of the loss modulus was read as the Tg value (glass transition temperature).

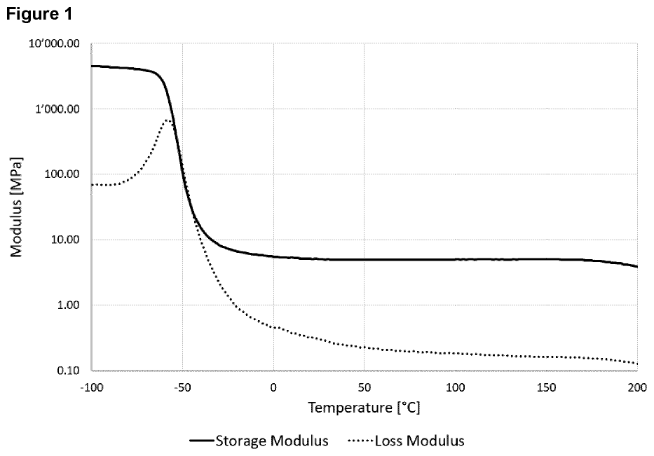

In FIG. 1, the curves for the storage modulus and the loss modulus of example 15 are given in relation to the temperature.

The dimensional stability after compression at 70 °C was determined based on DIN ISO 815-1 (determination of compression set). For this test, several test samples were prepared by applying the composition into a cylindrical mold with a diameter of 13 mm and a height of 6 mm. The surface was covered with a metal lid and the samples were cured in an oven for 1 h at 60 °C, followed by 23 h at 80 °C, removed from the mold and stored in standard climate for 24 hours. The exact height (thickness) of each cylindrical sample was then measured, followed by compressing the sample by 25% in height (i.e. to a height which was 75% of the initial height) by means of a press with two metal plates held together by 4 screws. The compressed samples were then stored in an oven at 70 °C for 94 hours. After cooling of the samples to room temperature, the compression was released, which allowed the cylindrical samples to recover. After a waiting time of 30 min at standard conditions, the recovered height was measured and the deformation was calculated in % by dividing the loss in height (i.e. initial height minus recovered height) based on the compressed height (i.e. 25% of the initial height).

For comparison of the dimensional stability after compression, SikaForce® 803 L45 (from Sika), a commercial two pack polyurethane adhesive filled with carbon black, with a Shore A hardness of 82, a tensile strength of 10 MPa, an elongation at break of 300% and a Tg of −40 °C, was also cured in the form of cylindrical samples with a diameter of 13 mm and a height of 6 mm by storage at standard conditions for 7 d followed by 24 h in an oven at 60 °C, and again 24 h at standard conditions, followed by testing these samples in the same way as described.

The results are given in Tables 6 and 7.

The reference example with SikaForce® 803 L45 is marked with “(Ref.)”.

TABLE 6
Compositions and properties of the Examples 1 and 2.

| Example | 1 | 2 |
|---|---|---|
| Isocyanate-Component: | | |
| Polymer P1 | 65.0 | — |
| Polymer P3 | — | 65.0 |
| carbon black ¹ | 34.9 | 34.5 |
| calcium oxide | — | 0.5 |
| p-tosylisocyanate | 0.1 | — |
| Catalyst-Component: | | |
| catalyst TMR-2 | 0.45 | 0.22 |
| viscosity (25 °C) [Pa · s] | n.d. | 126 |
| curing 1 h 60 °C/23 h 80 °C: | | |
| tensile strength [MPa] | 8.5 | 8.3 |
| elongation [%] | 176 | 236 |
| e-modulus 5% [MPa] | 7.3 | 6.9 |
| tear propagation [N/mm] | n.d. | 8.0 |
| Shore A | 74 | 72 |
| Tg [°C] | n.d. | −57 |
| after storage 7 d 100 °C: | | |
| tensile strength [MPa] | 9.5 | 10.1 |
| elongation [%] | 158 | 248 |
| e-modulus 5% [MPa] | 6.4 | 5.8 |

“n.d.” means “not determined”
¹ Monarch ® 120 (from Cabot)

TABLE 7
Dimensional stability after compression at 70 °C of the Examples
1 and 2 in comparison to a commercial polyurethane material.

| | | | SikaForce ® |
|---|---|---|---|
| | | | 803 L45 |
| Example | 1 | 2 | (Ref.) |
| dimensional stability after | 22% | 24% | 55% |
| compression at 70 °C: | | | |
| deformation | | | |

### Example 3

100 weight parts of the isocyanate component of Example 2 was mixed with several amounts of the catalyst TMR-2 as given in Table 8 (in weight parts) by the centrifugal mixer. For each mixed composition, the pot life was determined by viscosity determination (viscosity measurement as described for Example 2), whereby the bottom plate of the rheometer was heated to the temperature given in Table 8. The measurement was continued until the viscosity at the given temperature reached or exceeded 500 Pa's (=end of pot life).

TABLE 8
Pot life of Example 3 at different catalyst
concentrations and temperatures.

| | catalyst TMR-2 | | | | |
|---|---|---|---|---|---|
| Example 3: | 0.2 wp | 0.25 wp | 0.4 wp | 0.4 wp | 0.75 wp |
| pot life [min] | 25 °C: | 60 °C: | 60 °C: | 80 °C | 80 °C |
| | >60 | 13 | 6.5 | 2.4 | 1.8 |

Examples 4 and 5 (suitable for the use as thermally conductive gap filler) For each composition, an isocyanate component was prepared by mixing the ingredients given in Table 9 in the given amounts (weight parts) by means of a centrifugal mixer (SpeedMixer™ DAC 150, FlackTek Inc.) under exclusion of moisture and stored in a moisture-tight container.

A catalyst component was prepared in the same way by mixing the ingredients given in Table 9 and stored in a moisture-tight container.

Upon use, the isocyanate component and the catalyst component were mixed by means of the centrifugal mixer to obtain a homogenous paste which was immediately tested as follows:

The Shore A hardness was determined according to DIN 53505 with cylindrical samples of 20 mm diameter and a thickness of 6 mm which had been cured covered by a PTFE-coated foil and a metal lid for 7 days in standard climate.

The aspect was visually determined at samples which were prepared for the Shore A measurement by judging the surface and cutting them to expose the material inside.

The thermal conductivity was determined according to ASTM D5470-12 on samples cured during 7 days under standard climatic conditions. For the measurements, a TIM (thermal interface material) testing device (obtained from Zentrum für Wärmemanagement, Stuttgart, Germany) using the stationary cylinder method was used. Sample dimensions were: Diameter 30 mm, thicknesses 2 mm and 6 mm. The pressure parameters of the measurements were 1, 2, 3, 5, 7, 10 bar.

The results are given in Table 9.

TABLE 9
Composition and properties of the Examples 4 and 5.

| Example | 4 | 5 |
|---|---|---|
| Isocyanate component: | | |
| Polymer P5 | 3.3 | 3.3 |
| tris(2-ethylhexyl)phosphate | 9.8 | — |
| TEG-EH ¹ | — | 4.6 |
| ATH ² | 86.8 | 41.95 |
| calcium oxide | — | 0.15 |
| p-tosylisocyanate | 0.1 | — |
| Catalyst component: | | |
| catalyst TMR-7 | 0.15 | 0.1 |
| TEG-EH ¹ | — | 5.2 |
| aluminium hydroxide | — | 44.7 |
| (ATH) ² | | |
| curing 7d SCC: | | |
| Shore A | 31 | 30 |
| aspect | tack-free, | tack-free, |
| | no bubbles | no bubbles |
| thermal conductivity [W/mK] | 1.85 | n.d. |

¹ triethylene glycol bis(2-ethylhexanoate), plasticizer (from Eastman)
² surface treated aluminium hydroxide (Martinal ® TM-3810, from Huber Martinswerk), dried 10 h at 130 °C

1. Polyisocyanurate plastic containing
a) a cured polymer comprising, in relation to the total polymer,
at least 75 weight-% of polyether chains,
1 to 5.2 weight-% of urethane groups, and
0.7 to 7 weight-% of isocyanurate groups,
b) at least 20 weight-%, in relation to the total plastic, of at least one filler.

2. Polyisocyanurate plastic according to claim 1, wherein the content of polyether chains, in relation to the total polymer, is 75 to 97 weight-%.

3. Polyisocyanurate plastic according to claim 1, wherein the polyether chains consist of repetitive units selected from oxyethylene, oxy-1,2-propylene, oxy-1,3-propylene, oxy-1,4-butylene, oxy-1,2-butylene and mixtures thereof, whereby the content of oxyethylene units is less than 20 weight-% based on the total of the polyether chains.

4. Polyisocyanurate plastic according to claim 1, wherein the content of isocyanurate groups, in relation to the total polymer, is 1 to 6 weight-%.

5. Polyisocyanurate plastic according to claim 1, wherein the cured polymer contains moieties after removal of the two isocyanate groups selected from the group consisting of the isomeric diphenylmethane diisocyanates, the isomeric toluene diisocyanates, naphthalene-1,5-diisocyanate, 1,5-pentane diisocyanate, 1,6-hexane diisocyanate, isophorone diisocyanate, the isomeric dicyclohexylmethane diisocyanates and mixtures thereof.

6. Polyisocyanurate plastic according to claim 1, wherein the at least one filler is selected from the group consisting of calcium carbonates, barium sulfates, slate, silicates, magnesiosilicates, alumosilicates, dolomite, mica, fumed silica, carbon black, graphite, titanium dioxide, calcium oxide, calcium hydroxide, aluminium oxide, aluminium hydroxide, boron nitride, aluminium nitride, magnesium oxide, magnesium hydroxide, zinc oxide and any mixture of these fillers.

7. Polyisocyanurate plastic according to claim 1, wherein the amount of fillers, in relation to the total plastic, is at least 50 weight-%, whereby the polyisocyanurate plastic optionally further contains at least one plasticizer.

8. Polyisocyanurate plastic according to claim 7, wherein the polyisocyanurate plastic contains at least one filler selected from graphite, aluminium oxide, aluminium hydroxide, boron nitride, aluminium nitride, magnesium oxide, magnesium hydroxide, zinc oxide and any mixture of these fillers.

9. Polyisocyanurate plastic according to claim 1, containing, in relation to the total plastic,
2 to 10 weight-% of the cured polymer,
70 to 95 weight-% of fillers selected from graphite, aluminium oxide, aluminium hydroxide, boron nitride, aluminium nitride, magnesium oxide, magnesium hydroxide and zinc oxide, and
0 to 30 weight-% of plasticizers.

10. Polyisocyanurate plastic according to claim 1, wherein the polyisocyanurate plastic contains, in relation to the total plastic, at least 10 weight-% of fillers with a mean particle size below 1 μm, whereby the mean particle size is determined by laser diffraction analysis based on ISO 13320:2009, for example measured on a CILAS 920 particle size analyzer or on a Malvern Mastersizer 3000.

11. Polyisocyanurate plastic according to claim 10, containing, in relation to the total plastic,
40 to 80 weight-% of the cured polymer,
20 to 50 weight-% of carbon black, and
0 to 40 weight-% of plasticizers.

12. Polyisocyanurate plastic according to claim 1, wherein the deformation after compression at 70 °C of the polyisocyanurate plastic is less than 50%, determined with a cylindrical sample of 13 mm in diameter and 6 mm in height after compressing the sample by 25% in height to 4.5 mm at 70 °C for 94 hours, followed by cooling the compressed sample to room temperature, releasing the pressure and measuring the loss in height in % based on the compressed height of 1.5 mm.

13. A process to obtain the polyisocyanurate plastic according to claim 1, comprising the steps of
i) providing a composition comprising
at least one isocyanate-functional polymer which contains, in relation to the total polymer, at least 75 weight-% of polyether chains, 1 to 5.2 weight-% of urethane groups and 0.7 to 4 weight-% of isocyanate groups,
and at least 20 weight-%, in relation to the total composition, of at least one filler,
ii) adding at least one catalyst for the trimerisation of isocyanate groups, and
iii) curing the composition by trimerisation of the isocyanate groups.

14. Process according to claim 13, wherein the addition of the at least one catalyst in step ii) is performed by a static or a dynamic mixing procedure.

15. A gap filler, shock absorber, vibration or noise dampening material, coating, adhesive, or sealing material comprising the polyisocyanurate plastic according to claim 1.
